(19) United States
(12) Patent Application Publication
(10) Pub. No.: US 2002/0138630 A1
(43) Pub. Date: Sep. 26, 2002

(54) Music scheduling algorithm

(76) Inventors: Barry M. Solomon, Evergreen, CO (US); Eric Neumann, Denver, CO (US); David Juris, Greenwood Villages, CO (US); Patrick Brinkman, Centennial, CO (US); Carl A. Fischer, Golden, CO (US)

Correspondence Address: Michael S. Neustel, Suite No. 4, 2534 South University Drive, Gargo, ND, 58103, US

(21) Appl. No.: 10/026,038

(22) Filed: Dec. 19, 2001

Related U.S. Application Data
(63) Continuation of application No. 60/258,408, filed on Dec. 27, 2000.

(51) Int. Cl. G06F 15/16

(52) U.S. Cl. 709/228

(57) ABSTRACT

A music scheduling algorithm (MSA) is provided for programmatically and dynamically creating a unique play list for each listener of an Internet radio service. The play list includes a mix of music influenced by user rated songs and artists and music the MSA infers the user will like. The MSA is provided a regularly updated pool of various music lists from which to select lists allowed by the user selected radio station affiliate. The MSA then factors in user rated songs and artists, user deletions, user music mix gauge settings, calculates user deep cut songs and performs music correlations of unrated songs to further define the play list. The user music mix gauges include the New Music Gauge to select a percentage selection of new music (uncharted music of the same genre) and hit music versus gold music, an optional Deep Cuts Gauge to influence the play list percentage mix of album deep cuts versus affiliate and national music and a Music Selector Gauge to select a relative amount of music drawn from each selected music format.

### CROSS REFERENCE TO RELATED APPLICATIONS

I hereby claim benefit under Title 35, United States Code, Section 119(e) of United States provisional patent application Serial No. 60/258,408 filed Dec. 27, 2000. This application is a continuation of the No. 60/258,408 application. The No. 60/258,408 application is currently pending. The No. 60/258,408 application is hereby incorporated by reference into this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to an algorithm to determine a music play list. More specifically, the present invention provides a music scheduling algorithm (MSA) for dynamically creating a unique music play list for the individual Internet radio listener.

With the proliferation of connections to the Internet by a rapidly growing number of individuals, the viability of the Internet as a widely accepted medium of communication and business activity has increased correspondingly. The Internet is comprised of a global computer network allowing various types of data to be transmitted including but not limited to video, audio and graphical images. The type of connection the individual has to the Internet determines the overall quality and speed of their Internet experience. With increasing bandwidth and decreasing prices of Internet connections available to consumers such as DSL, ISDN, T1, T3 and cable modems, increased usage and quality of Internet related activities will inevitably occur.

2. Description of the Prior Art

Amplitude modulated (AM) radio broadcasting began in the early 1920's and became mobile with the advent of the transistor in 1954. By the mid 1970's, most AM radio, college and start up broadcasters selected the higher frequency modulated (FM) band to provide a higher quality broadcast in stereo without the susceptibility to audio noise common in AM radio reception.

Currently, broadcast radio provides few choices to the listener. The power of the typical FM radio station's transmitter reaches about 100 radial miles; consequently, the available broadcasts and associated formats, is limited to a couple of dozen choices to the listener in any given location. Broadcast radio programming is increasingly controlled by smaller numbers of media conglomerates such as Cox, Jefferson-Pilot and Bonneville. This has led to more mainstreaming of the programming on broadcast radio, as stations often try to reach the largest possible audience to increase advertisement fees. Pop music radio dominates the airwaves since demographically, it has been identified that teenagers and young adults spend a large percentage of their income on fast food and music. The radio content through mainstreaming has resulted in a dilution and minimization of the content desired by the listener. Many “popular” radio stations, other than public radio, schedule in short bits of local or national news that is little more than headlines in between the latest hit song all sandwiched between as many lengthy commercials as the average listener can tolerate.

Internet radio has been an option to terrestrial radio since the late 1990's made popular by the wide range of music formats and programs offered. Traditional radio broadcasters have used the Internet to simulcast their broadcasting. Even with the larger selection, albeit from narrower categories within the formats, these broadcasts are also programmed to appeal to the masses, pleasing few.

Throughout the technical advances in radio type broadcasts, broadcasters have generally relied on simple approaches to scheduling the daily programs, including music. WWOZ Internet radio is primarily a Jazz format radio station out of New Orleans that actually allows the show host to decide what to play and occasionally lists the music for later review. On the other hand, Wisconsin Public Radio features state news and classic music where the music play list is scheduled and posted six weeks in advance with requests on Saturday. The Internet user can open the WPR website and browse through a calendar to any selected day to see the hourly scheduled music past, present and future. Internet radio Live365 offers several broadcasting methods to broadcasters including relayed broadcasts that originate on another site but can be listed in Live365's broadcast directory. With Live365's suite of products, the Internet browser can select a favorite private or commercial broadcast from a play list of broadcasters and listen to it online. Live365 is an example of niche radio, an attempt at personalized music scheduling for Internet radio. Generally, radio stations follow a primary format of Rock, Country, and Jazz etc. and play “canned music” where the music is assembled for play from a national play list with daily rotation of current hits.

Unfortunately, Internet radio, like terrestrial broadcast radio, is also governed by a person or group of people that determine what is played. While these radio programs may be suitable for the particular purpose to which they address, they can not be programmed to dynamically create an individual play list desirable for each listener.

In these respects, the music scheduling algorithm (MSA) according to the present invention substantially departs from the conventional concepts and designs of the prior art, and in so doing provides a method primarily developed for the purpose to program and dynamically create a unique music play list for each individual listener of an Internet radio service.

### SUMMARY OF THE INVENTION

In view of the foregoing disadvantages inherent in known methods to schedule music in the prior art, the present invention provides a new music scheduling algorithm (MSA) that can be used for programmatically and dynamically creating a unique play list for each individual listener of an Internet radio service. The MSA produces a play list of the music a listener likes, introduces new music and does not play music he explicitly does not like.

Initially, the MSA selects music for the individual listener based on the user's selection of an affiliate's play list, from national play lists of various formats, newly released music, songs that radio stations or record labels want to emphasize and songs that previously were hit songs but are no longer on the charts. The MSA follows the affiliate's list update and new promotional music can be added at any time. Later, the user's input of rated songs and artists, choice of musical genres, selected amount of hit music versus gold music and rated deep-cuts of an album partly determines the subsequent play list. The MSA contributes to the music mix by inferring by statistical analysis what other songs the user would like and by subjectively marking an artist and/or song as being more popular. The MSA provides a default play list for the individual in the event that the listener's choices have limited the minimum number of song choices available to the MSA to assemble for a play list. Finally, the MSA is designed to follow the rules set forth in the Digital Millennium Copyright Act (DMCA), enacted by the U.S. Congress in 1998.

It is to be understood that the invention is not limited in its application to the details of construction and to the arrangements of the components set forth in the following description. The invention is capable of other embodiments and of being practiced and carried out in various ways. Also, it is to be understood the phraseology and terminology employed herein are for the purpose of the description and should not be regarded as limiting.

A primary object of the present invention is to provide a music scheduling algorithm (MSA) that will overcome the shortcomings of the prior art devices.

An object of the present invention is to provide a music scheduling algorithm for programmatically and dynamically creating a unique play list for each individual listener of the Internet radio service. The play list includes music the listener has indicated desirable and music the MSA has inferred desirable.

Another object is to provide a music scheduling algorithm that takes the updated play list and song rotation scores of a popular radio station the listener has selected and programmatically uses the selection as an influential factor in determining an individual listener's unique play list.

Another object is to provide a music scheduling algorithm that creates a database of the listener's rated song inputs to programmatically derive correlations to similar songs to be used in the play list.

Another object is to provide a music scheduling algorithm that programmatically provides the proportions of newly-released music and of each radio format the user selects is desirable in the play list.

Another object is to provide a music scheduling algorithm that programmatically provides a default play list in the event that a listener's choices have overly limited the song choices available to the MSA to assemble for a play list.

Another object is to provide a music scheduling algorithm that accepts programmatically songs that the individual listener deletes from the play list for permanent deletion from the play list regardless of popularity in the general public.

Another object is to provide a music scheduling algorithm that programmatically fulfills the current and future requirements of the Digital Millennium Copyright Act.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a flow diagram overview to assemble the unique individual play list by the Music Scheduling Algorithm.

FIG. 2 depicts the step to gather Music Lists.

FIG. 3 depicts the step to perform the Music List Merge.

FIG. 4 depicts the step to factor in the User Calibrators.

FIG. 5 depicts the step to factor in the Global Calibrators.

FIGS. 6A-B depicts the step to factor in Dynamic Calibrators.

FIG. 7 depicts the step to apply Rules.

FIG. 8 depicts the step to apply Other Factors.

FIGS. 9A-H depicts changes to the music mix of the play list due to sequential changes provided by the user.

FIG. 10 shows a simplified diagram of the Internet environment in which the inventive solution is applied.

### DESCRIPTION OF THE PREFERRED EMBODIMENT

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital video discs), and computer instruction signals embodied in a transmission medium (with or without a carrier wave upon which the signals are modulated). For example, the transmission medium may include a communications network, such as the Internet.

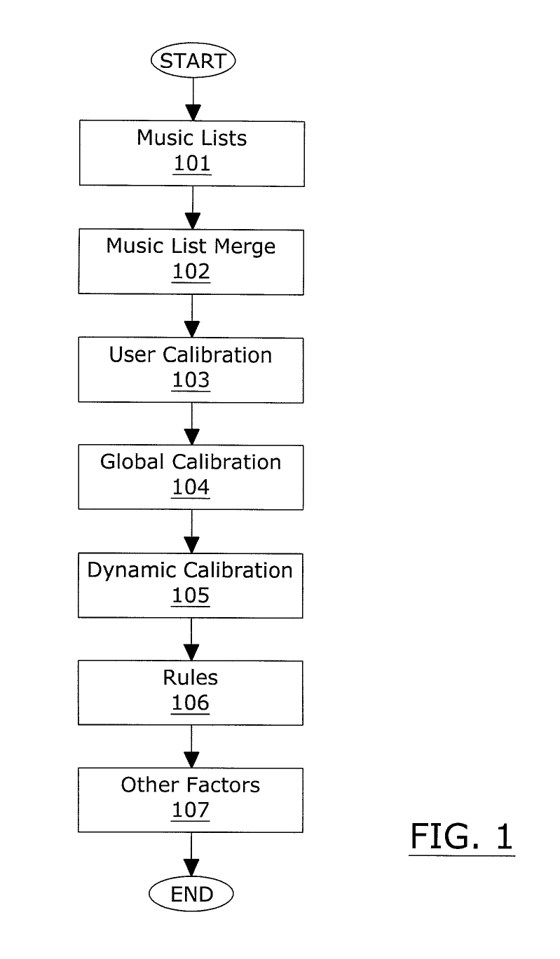

FIG. 1 shows a flow diagram 100 to give an overview of the sequential contributing elements that compose the Music Scheduling Algorithm. A brief description of each step follows. In the first step 101, the Affiliate and National play lists and Gold Lists for each format are gathered. The Affiliate Music Pools (AMP) and the National Generic Music Pools (NGMP) are generated. A New Music pool is prepared. Next, the music merge is performed 102. The selected AMP is used to replace the NGMP of the same format; other formats not allowed by the specific affiliate are rejected. Also, the user rated songs are gathered for additional processing. In the next step, the user calibrators 103 are factored in the music pool. User calibrators include user song ratings, user artist ratings, user deletes and associated song correlation ratings. Next, the global calibrators 104, such as artist popularity and song popularity, are factored in further defining a play list. In the next step, the dynamic calibrators 105 are factored in the music pool. Dynamic calibrators include user selected music selector settings and new music gauge settings and pooled music versus user rated Deep Cuts. Next, the DMCA rules 105 are applied to the music pool to remove any songs that would cause potential violations. In the final step, an emergency play list 105 is created in the event any user selections and deletions have left too few songs in the music pool for the MSA to assemble a play list.

A list of definitions follows to best define the elements used by the MSA in assembling the unique individual play list:

Music Types

Hit—A song that is currently a “current” or “recurrent” song on an R&R play list or marked as a hit by the MSA system for non R&R formats. Programmatically, these songs are stored per affiliates' play list tables and per format in the national play list tables.

Gold—All songs considered by Billboard or other music charting services to be a hit song from the past. Programmatically, these songs are stored per affiliate in the affiliates' gold tables and in each format in the national gold tables. Songs in the play list tables that no longer have R&R rotations can automatically be migrated to the gold tables. Conversely, songs in the gold tables that attain R&R rotations can automatically be migrated back to the play list tables.

New Music—A TMC Hit Disc song or a song provided by a record label that has not yet charted on the R&R list. These songs do not normally exist on any radio station's play list. New releases can be manually added to any or all affiliate's play list within a given format at the request of either the affiliate or a record label. When added, these songs will take on a default rating of 3, but this rating can be changed through the use of global calibrators.

Deep Cut—A song on an album that is not considered a Hit, a Gold song or a New Release. The MSA considers Deep Cuts only if a user has rated them. Programmatically, Deep Cuts reside initially in the subscriber's ratings table and are temporarily placed into a deep cut table for MSA selection purposes.

Rated Music—Once a user has applied a rating to any song, regardless of where that song was originally classified, it will be considered to be a user rated song and will be treated differently from all other unrated music.

Play List Types

Affiliate Play List—A list of songs and their relative number of plays (rotation) taken from R&R or provided by the affiliate if the station is not an R&R reporter.

Affiliate Gold List—A list of songs provided by the affiliate that is played by the affiliate but is not listed as current or recurrent by R&R.

National Play List—A list of songs and their relative number of plays (rotation) taken from R&R for a given musical format or generated by the MSA system for non-R&R formats.

National Gold List—A list of songs representing all the gold songs assigned to a particular format.

Affiliate Music Pool (AMP)—The sum total of songs in the Affiliate Play List normalized to rating values of 1 through 5, and Affiliate Gold List set to rating values of 1. This can be derived once R&R or the affiliate has reported the (weekly) updates.

National Generic Music Pool (NGMP)—The sum total of songs in the National Play List, normalized to rating values of 1 through 5, and the National Gold List, set to rating values of 1. This can be derived once R&R has reported the updates.

User Rated Song Pool (URSP)—A pool of songs that the user has rated. Songs in this pool are treated separately from unrated songs by the MSA and contains ratting values from 1 through 5.

New Music Pool (NMP)—A pool of songs made up of new or promotional music that is not currently being played by radio stations. Songs in this pool are stored with data keying them to their primary format and are treated separately from all other music pools by the MSA.

Other Definitions

Session—A block of time a user is listening to the Internet player. This time terminates when the user logs out or when a complete play list of songs plus associated introductions, commercials, greetings and other elements have been played.

Format—All songs classified as to the particular musical genres that the song belongs and the type of song it is considered to be in each of these formats.

Radio Network Service (RNS)—An Internet Radio service that provides the inventive solution, a MSA to determine the play list to be played to the individual listener.

Radio and Record (R&R)—A music industry magazine that reports the number of times a given song is played.

Each step identified in FIG. 1 and discussed in the overview above, will now be described to fully illustrate each functional step of the MSA to create a unique play list for each Internet radio user.

Music Lists

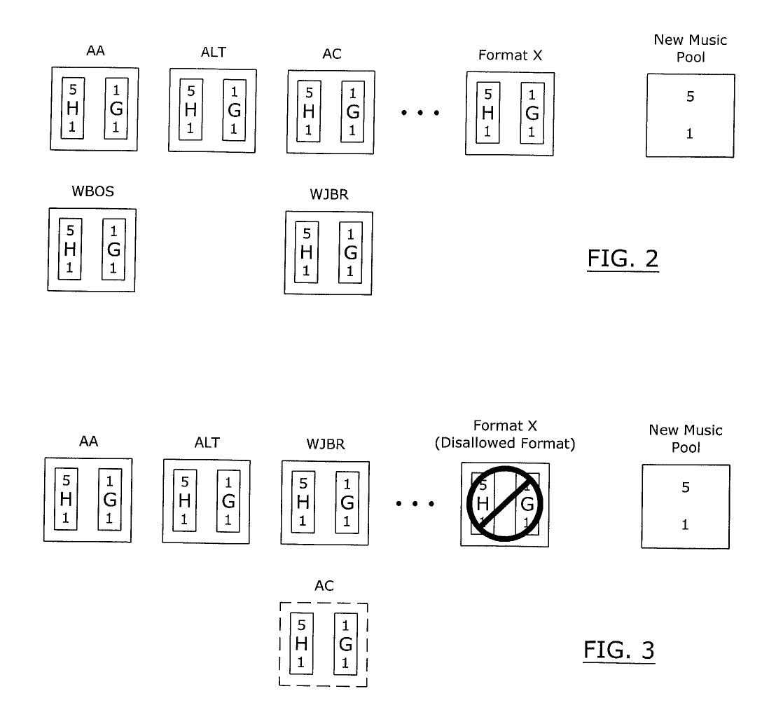

FIG. 2 represents the first operational step to gather music lists and form the initial music pool. The creation of these pools is accomplished regularly (weekly) following the R&R update. This database is not assembled by the MSA but used by the MSA as the initial music pool to begin to assemble a unique play list. Radio stations join as affiliates to the Internet Radio Network service and are required to weekly supply their Affiliate Play List and the Affiliate Gold List as well as define which formats their listeners will be allowed to listen to. The affiliate may select from one to sixteen formats or sub-formats from a list that is currently over one-hundred and continuing to grow. Some examples of the formats offered are:

1) CHR/Pop

2) CHR/Rhythmic

3) Urban

4) Urban Adult Contemporary

5) Country

6) NAC Smooth Jazz

7) Adult Contemporary (AC)

8) Hot AC

9) Adult Alternative (AA)

10) Alternative

11) Rock

12) Active Rock

13) Classic Rock

14) Oldies

15) Rhythmic Oldies

16) 80's and Beyond.

Some affiliates maintain a narrow identity, selecting a single format and a few related sub-formats, such as “Country” with “Rock-a-billy” and “Bluegrass” for example. Other stations select several broad music genres, allowing the user to choose from a broad spectrum of musical possibilities. This approach is essentially understood by the user in selecting the affiliate for play. Without submitting the affiliate play list, a default play list per format may be determined by conglomerating the play lists of radio stations within the same format.

In the preferred embodiment of the invention, The Radio Network Service (RNS) is intended to run transparently to the Internet radio user. The user selects Internet radio through the radio station of choice, intending to receive the range of music supported by the radio station. The user experiences the look and feel of the radio's Web site despite the fact that the request is passed to a MSA server for play list determination and a production server for program play, both operated by the RNS. A user identification code is passed with the request such that the RNS correctly identifies the affiliate, any previous user selections or files and affiliate associated advertisements. The user typically downloads a player from the station Website while the RNS builds a play list through the MSA for subsequent play.

In addition to the affiliate song lists, the RNS also collects, or has on a server database, the weekly National Play Lists and Gold Lists for each format. The rotation values are normalized to a scale of ratings from 1 through 5. These 1-5 scale levels are configurable on a per affiliate basis. For example, a 5 might equate to the top 10% of rotations, a 4 to the next 15% and a 3, 2 or 1 to the next 25%, 25% and 25% respectively. This method will allow the MSA to control the relative amount of 5s compared to Is. Additionally, these settings could be used to ensure that no 5s are delivered by default (set the 5s to 0%), thereby allowing additional control of the relative importance of user ratings and global ratings. For the Gold portion of the list, The Affiliate's Gold songs are set to a rating value of 1 as are the National Gold songs.

The National Generic Music Pools are generated for each format using R&R data or RNS generated for non-reporting formats. The NGMP Hits pool is normalized to a scale of ratings 1 through 5. The NGMP Gold side is set to a default rating of 1.

The New Music Pool is compiled from new and promotional songs. As songs from this pool begin to chart, they will be removed from this pool and automatically placed in the appropriate affiliate and/or national pools. A date/time stamp will be used for entries into this pool to allow the removal of songs that have exceeded a certain shelf life. The songs in this pool may all carry the same rating to ensure an equal probability of play, or they may be rated on a 1 through 5 scale to weight their rotations.

Music List Merge

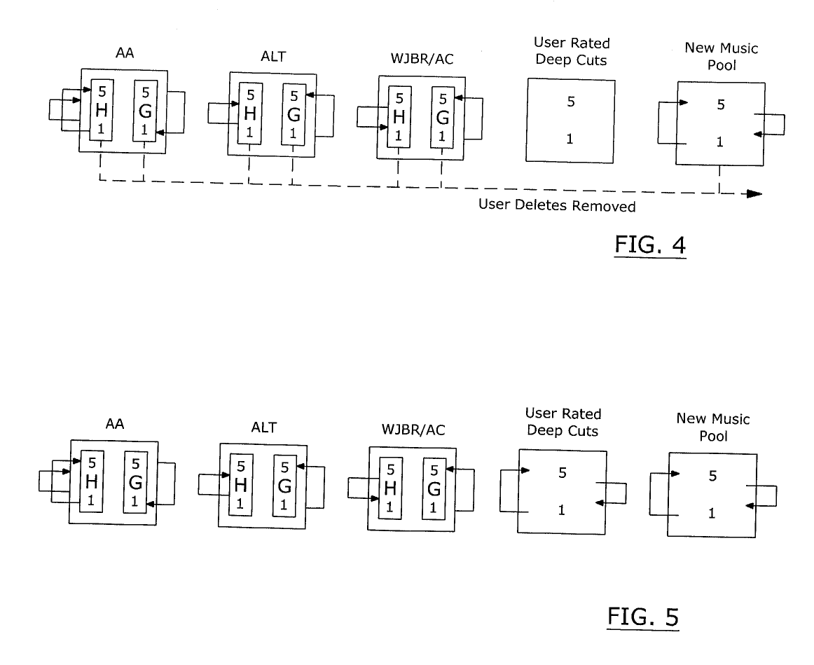

FIG. 3, in comparison to FIG. 2, illustrate the music list merge process. The user music merge begins with the National Generic Music Pools. All NGMPs are removed from the pool (format X) that does not correspond to the user's affiliate primary and other authorized formats. Also, the Affiliate Music Pool is substituted for the NGMP of the Affiliate's format (WJBR of primary format AC replaces the NGMP AC). The MSA attempts to choose as many songs as possible from the Affiliate's AMP and the Affiliate's format NGMP is used as a back-up, if the DMCA rules and user deletes prevent the AMP from being large enough to meet requirements. This applies for both the Hit and Gold portions of the AMP.

User Calibrators

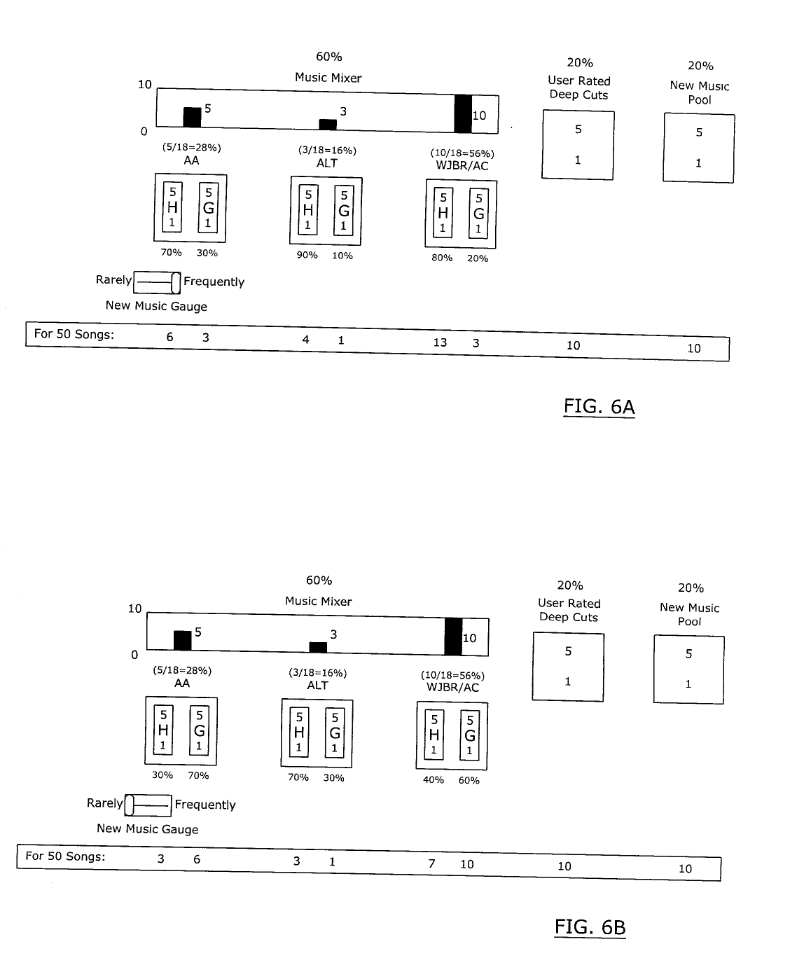

FIG. 4 illustrates the process to apply user calibrators. User Calibrator values are comprised of the explicitly defined values from a user's song and artist ratings and the implicitly defined values resulting from the RNS correlated music values.

The user's rated artists are collected and stored on a server database for each user. However, at the time of the rating, whether through the player or the artist's page, the artist's user rating is immediately converted to individual user song ratings by applying the artist rating to all of the artist's current Hit and Gold music that has not previously been rated. The user is then able to re-rate any individual song. In this way, user artist ratings are converted to user song ratings and are treated as any other user rated song.

The initial implementation of this process will consist of a conversion only at the time of the initial artist rating. If a rated artist later releases new material, that material will be added as unrated and will therefore be available to play as part of the unrated music pools. Further programming may eventually be accomplished that would create a background process to update each individual user's accounts based on their previous artist ratings. New material for previously rated artists would be treated with the previous artist rating.

There is no need to collect user rated songs into a separate music pool since they are collected and stored on a server database for each user. Since the music pools are all normalized to a rating value of 1 through 5, user's song ratings are applied by taking the user's ratings and overwriting the existing value for the particular song within any music pool in which that song appears. In this way, user's song ratings only modify the relative positioning of a song within a particular play list. There are usually additional songs remaining from the user's rated song table after matching the user's song ratings to all of the affiliate allowed music formats. These left-over songs will be considered to be a user's Deep Cuts and will be placed into a temporary table that will be used by the MSA when selecting songs for the final play list. The relative amount of songs selected from this category is controlled by a variable stored on a per-affiliate basis. This variable value is initially set to 20% of the final play list. Next, the user's deletes are removed from the remaining pools.

The weekly updated play list of the affiliate radio station is the greatest factor in determining the listener's play list if the user does not rate songs or artists or delete songs. The player presents the user with a song rating system: X, 1, 2, 3, 4 or 5 where X is delete, 1 is play rarely and 5 is play as much as possible. The user can choose to rate the song that is currently being streamed over the player and/or rate the current artist. The user also has the option to select a specific button to link to a Website that provides a proactive method to rate any artist or song.

Once the user has rated songs, the MSA is equipped to correlate pooled songs with the user rated songs to be used in the play list. Correlation values are applied by overwriting any existing value of any song that the user has not already rated with the user's correlated value since the music pools are all normalized to a rating value as described previously for the music lists. The exact implementation will depend on whether the MSA will use rated music pools from a MusicTek database or a database already formed by the RNS. With correlated selections, the MSA is then influenced to select correlated songs along with selections from the affiliate radio station lists as well as replaying user highly rated songs in due time.

Global Calibrators

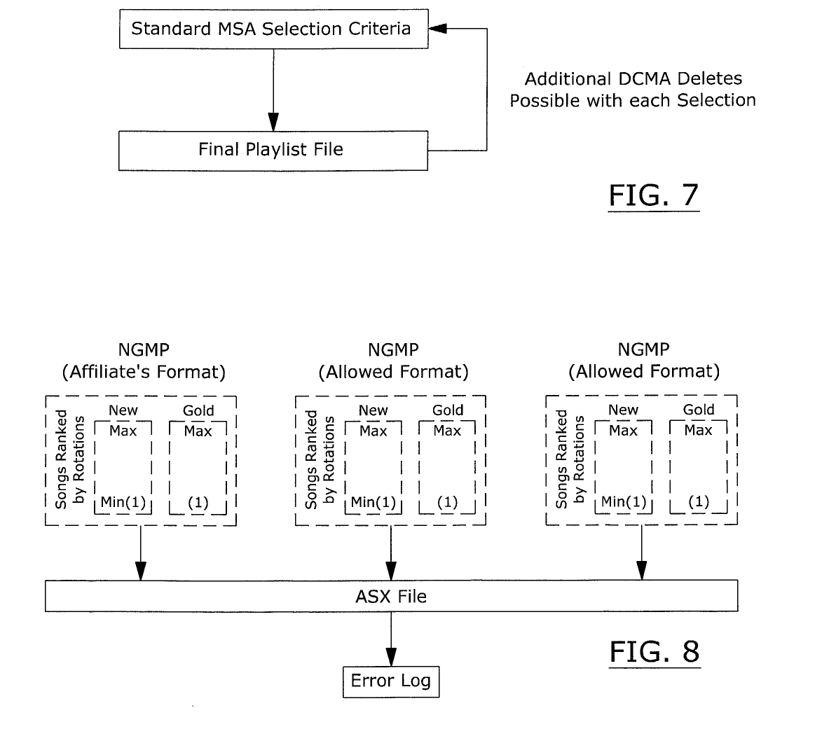

FIG. 5 illustrates the process to apply Global Calibrators which are artist and song popularity. The RNS, using a rating scale of 1 through 5, sets global artist and song popularity values. In actual practice, it is likely that only values of 4 and 5 will be used to obtain the desired effect on the music pools; however, it is possible to lower an artist's or song's popularity. The globally specified values are then used to overwrite any existing values of any song within any pool. The RNS also has the ability to use the globally specified values to overwrite any song or artist rating under the direction of an affiliate or record label. Since these changes are temporary and will be done on a small scale, it is anticipated that most user's will not notice the overwrite. In any case, the user's actual rating will always be displayed while the song is playing.

Dynamic Calibrators

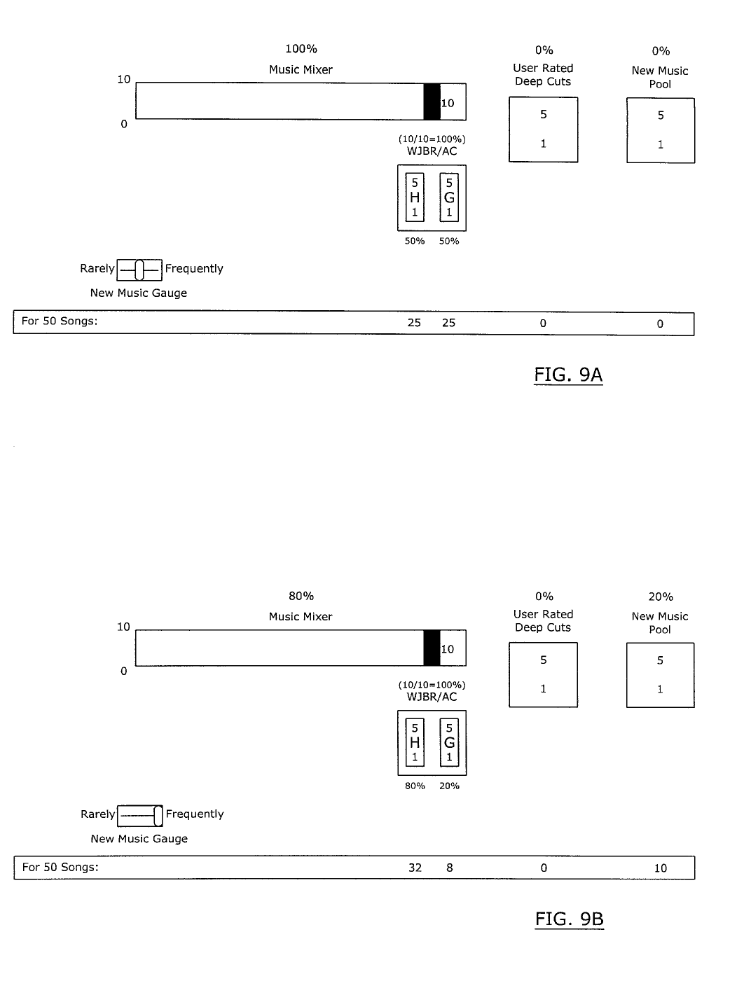

FIGS. 6A and 6B illustrates the song selection mix from the various remaining music pools and the New Music Pool determined by the Dynamic Calibrators. The New Music Gauge is presented through the Internet player to the user to allow a configurable percentage of selections from the New Music Pool. This percentage is stored on a per affiliate basis and will vary from a level of no New Music added corresponding to middle position of the gauge up to the maximum amount allowed corresponding to the gauge's right most position. An equivalent gauge setting that corresponds to values 1, 2 and 3 equates to a “0” percentage selection from the New Music Pool. The value 5, where the New Music Gauge is set to maximum or “Frequently”, corresponds to the maximum value allowed on a per affiliate basis or about 20%. The equivalent value of 4 on the user selected New Music Gauge correspond to ½ the maximum value or 10%. It is important to note that despite the user's New Music Gauge setting, a calculation will be performed each session based on a user's number of deletes. This calculation may allow New Music Pool selections to enter into a user's play list, despite the fact that the gauge corresponds to a 0 percentage value for new music.

The New Music Gauge will also directly affect the proportion of Hit music versus Gold music chosen from within each format pool. Each format pool is scaled 1 to 5 where 5 represents the maximum amount of Hit music and 1 represent the minimum amount of Hit music. All five levels for this gauge are set on a per affiliate per format basis as well as the default value (usually set to 3).

To calculate overall mix percentages, the stored per affiliate user rated percentage and the calculated new music percentage will be added together and then subtracted from one hundred percent (100%-20%=80%). The remaining percentage is the amount of the music drawn from the affiliate and national music pools (AA, ALT and WJBR/AC).

A mix value stored for each affiliate controls the overall mix of music drawn from the affiliate and national music pools versus user rated Deep Cuts. This value is provided to assure that hit songs from the affiliate and national pools maintain the best chance of playing while still allowing some of the user's Deep Cuts to play. In the example of FIGS. 6A and 6B, 80%=60% (affiliate and national pools)+20% (Deep Cuts). The user deep cut setting could later become a gauge on the player with controllable settings similar to the New Music Gauge.

The Music Selector Gauge settings are also used to determine the Music Mixer of FIGS. 6A and 6B, the relative sub mix (sub divide portions of the overall 60% assigned to Music Mixer) of the remaining format pools of music (AA, ALT and WJBR/AC). The Music Selector range for the allowed formats is 0 to 10 where 0 represents no music from the format with the exception of user rated songs regardless of format. FIG. 6A illustrates an example to calculate the mix: user's affiliate is WJBR primarily formatted for adult contemporary (AC) and always set to 10 with acceptable format AA set at 5 and ALT set at 3. The music selector total value equals 18. The format settings (10, 5 and 3) are divided by the music selector total to determine the percentage of music that should be allocated from each pool. In this example, AA: 5/18=28%, ALT: 3/18=16% and AC: 10/18=56%.

Finally, the above mix percentages are used to calculate the mix of 50 songs required to build a play list of 50 songs as shown in FIGS. 6A and 6B: (Fifty songs is derived from a three hour session or, given each song lasts 3.6 minutes, 3.6 min×50 songs=180 minutes.)

| | | |
|---|---|---|
| User Deep Cuts: | 50 songs × 0.2 (20%) = | 10 songs |
| New Music Pool: | 50 songs × 0.2 (20%) = | 10 songs |
| Music Mixer: | 50 songs × 0.6 (60%) = | 30 songs |

| | |
|---|---|
| Total | 50 songs |

The 30 songs of the Music Mixer are calculated by:

| | | |
|---|---|---|
| AA Hits: | 30 × 5/18 × 0.7 = | 6 songs |
| AA Gold: | 30 × 5/18 × 0.3 = | 3 |
| ALT Hit: | 30 × 3/18 × 0.9 = | 4 |
| ALT Gold: | 30 × 3/18 × 0.1 = | 1 |
| AC Hit: | 30 × 10/18 × 0.8 = | 13 |
| AC Gold: | 30 × 10/18 × 0.2 = | 3 |

| | |
|---|---|
| Sub Total | 30 songs |

A user may select few or no user Deep Cuts. Accordingly, the MSA must be programmed not to select the entire user Deep Cuts for each play list that is generated as this would cause repetition and violation of DMCA rules. Ideally, the user has selected 50 Deep Cuts providing a large enough pool such that when the current default of 20% of these songs is selected, the user would not hear a significant degree of repetition until five complete play lists have been heard or approximately 18 hours of music has been played. Once a threshold number of Deep Cuts (50) has been met, the algorithm for selection within the user's deep cut pool will work the same as that for selecting songs in the Music Mixer. This algorithm totals the value of all of the ratings in the pool and sets the probability of selecting each song to the songs rating divided by the pool total. Once a selection has been made, the song is removed from the pool and the pool total is recalculated thereby changing each song's new probability of being selected.

Prior to the threshold number of user Deep Cuts being met, two methodologies are incorporated to avoid over-selection of a limited number of rated songs and a skewing of a limited number of rated songs into a situation where low rated songs are over selected. The first method will rely on tiers prior to the main threshold. The tiers will reflect the total number of ratings, and an additional parameter that determines the percent chance of success when requesting a song from the user's rating pool. If the attempt is not successful then a song will be pulled from the unrated pools according to all of the normal criteria. For example, a user has rated 35 songs which correspond to a tiered value or a 60% chance of success. With the affiliate's user deep cut factor set to 20%, 10 out of 50 songs would normally come from the user's deep cut pool. However, with only a 60% success rate, there would be 0.6×10 songs, or 6 songs selected from this pool. The remaining selections (for non-successful chances) will be made from the non deep cut pools. The second methodology involves a slight change to the selection algorithm. Rather than remove each song from the user's pool as it is selected, the probability “slot” is flagged as having been used. If a subsequent random number generation later arrives at the same slot, then a song will be selected from the non deep cut music pools according to all of the normal criteria. The threshold amount and the (five) tiered values are configurable on a per-affiliate basis.

The overall number of user deletes will be gathered for a similar type of tiering for the amount of new music to be played with reference to a threshold of 50 deletes. For example, a user has deleted 35 songs which correspond to a tiered value of 60% of the maximum threshold value which is set at 20%. Selections from the New Music Pool will be 0.6×20% or 12%.

Since all of the music pools are now effectively normalized to a range of 1 to 5, a Global Rating Scaling Factor is applied for each type of pool. This will fine tune the overall effect of each rating relative to one another without being restricted to a linear comparison model. Each of the Global Rating Scaling Factors are initially set to a value of 2 and programmatically applied by raising value to this power. For example, with a Global Rating Scaling Factor of 2, the following represents the song rating and the final effective rating (song rating squared) used the music pool.

| Song Rating | Final Effective Rating |
|---|---|
| 1 | 1 |
| 2 | 4 |
| 3 | 9 |
| 4 | 16 |
| 5 | 25 |

All of the effective ratings will be totaled across the entire pool, and then each song's chance of being played will equal the song's final effective rating divided by the pool total. In this way the relative importance of the meaning of a 5 for each type of pool is controlled.

Changes made to Dynamic Calibrators (the Music Selector Gauge and New Music Gauge) are quickly used to adjust the MSA play list. This is initiated when the user clicks an “Apply Changes” button that will update the combined settings on the MSA server. This server will then prepare a revised play list to be used by the player as soon as it becomes available. Remaining elements from previous play lists will be purged to make the new play list available as soon as possible after the song currently playing.

Rules

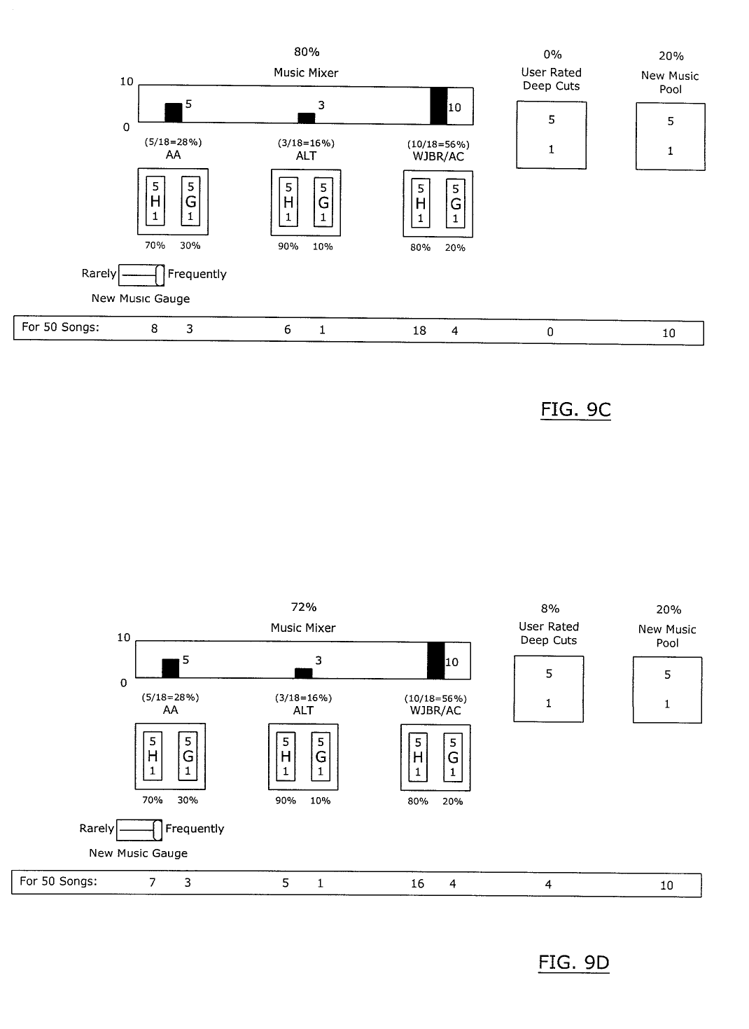

FIG. 7 depicts the step where the Digital Millennium Copyright Act (DMCA) rules are applied by the MSA. The MSA is programmatically altered to comply with changes or clarifications to the DMCA. The key components for compliance are detailed in this quote from Webcaster.org, International Webcasters Organization as follows:

Sound Recording Performance Complement. The transmission cannot exceed the “sound recording performance complement” which has two components:

(a) On a particular channel, within any three hour period, the programming can contain no more than three selections from any one phonorecord (album or CD), and no more than two such selections can be played consecutively. For example, on the Eric Clapton Journeyman CD, within a three hour period, a particular channel could play the selections, “Pretending”, “Bad Love” and “Hard Times” but only two of those selections could be played consecutively; and

(b) On a particular channel, within any three hour period, the programming can contain no more than four different selections by the same featured artist or from any set or compilation, and no more than three such selections can be played consecutively. For example, within a three hour period, a particular channel could play four (4) selections by Madonna: one from Like a Virgin, one from True Blue, one from Who's That Girl and one from Like a Prayer. Under this scenario, any three of these selections could be played consecutively. However, if three of the selections are from Like a Virgin, the rule above must be observed and only two of the selections could be play consecutively.

In most circumstances, this sound recording performance complement provision is not applicable to broadcast retransmissions if the transmitting entity does not have control over the content of the original broadcast. However, to maintain this exemption, the transmitting entity must notify the broadcaster if the broadcast programming regularly exceeds this sound recording performance complement.

Primarily, the rules to be adhered are a) per 3 hours, a maximum of 3 songs per album with no more than 2 consecutively from an album and b) per 3 hours, a maximum of 4 songs per artist with no more than 3 consecutively. For simplification, the MSA is programmed to allow no more than three songs from a given artist in any three hour period.

User's that continually skip and delete songs will shorten the amount of time between the play list generation processes. In these situations, the DMCA rules will still prevail based on the time/date stamp for the previous play of any given song. With each subsequent play list generated, only those songs meeting the DMCA criteria will be available for play.

A special business rule is applied to the resulting songs to ensure there are a sufficient number of highly rated songs identified so that the first and second song of a session and the first song following each commercial played will be a highly rated song. A highly rated song is either explicitly rated as such by the user or is an unrated Hit song near the top of the weighted R&R chart. The special rule will take into account the number of rotations of each song selected from each portion of each pool involved in the selection process. A calculation will be done based on the number of required commercials per hour to determine the required number of commercial following songs (+2 for the initial songs) for the session. This number will then be used to pick the required number of highly ranked songs. These songs will be manipulated via the player to insure they are played at the appropriate time.

The MSA based Radio Network Service is configured so as to not be an interactive service under section 114(F) of the Copyright Act. The RNS is not an interactive service according to DMCA on the following grounds: the recording companies and the radio stations have all the influence over the play lists of any radio station affiliate of the RNS, not the user and the user selected music mix gauges blends new hits and gold hits in a mixture that is partially influenced by the user.

Other Factors

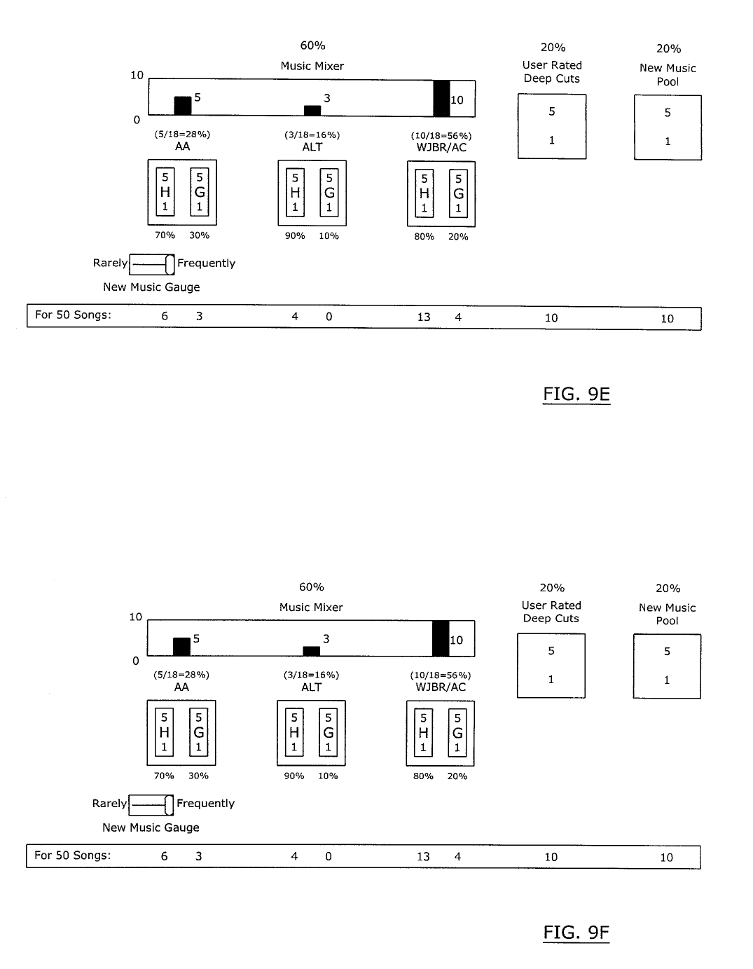

FIG. 8 illustrates the steps to generate and file an emergency playlist. The MSA will generally not need to provide an emergency play list due to the large library of songs. However, if the Hit music or Gold music databases get corrupted, the MSA is authorized to play any music within the allowable formats until the problem is resolved. Errors of this nature will be logged and generate an alert in the error subsystem to alert system operators to the problem. It would be unusual but possible that the user has deleted so many songs so as to force the use of an emergency play list. When this anomaly is detected, it will be handled on a per-user basis with an option by the RNS to undelete all or a portion of the deleted songs for that user.

User song and artist deletes are taken into account immediately. This is not an issue for song deletes since they result in an immediate skip of the currently playing song and the song can appear only once in a play list. However, the MSA must assure that any additional songs by a deleted artist in the current play list are not played. This is accomplished from the player application on the user's desktop with a temporary list of deleted artists that can be compared against any queued play list, skipping the deleted artist's songs until a new play list is generated taking into account the actual deletes. User deletes will be reverse correlated to increase the likelihood that a user will hear songs ordinarily not heard which effectively expands a user's play list. Additionally any song or artist that is deleted may be “un-deleted” by the user at any time by simply accessing the appropriate artist's page or through the user's history page. User ratings that occur during a session will not be taken into account until the next session.

The RNS maintains a log of user activity. First, the RNS database keeps a log of each song that is actually presented to the user. Data is written to a log file/table that includes the subscriber identification (from which the affiliate and affiliate's format may be derived), a time/date stamp, the song that was presented and the user's action taken. The user's action includes skipped the song, deleted the song or played all or a definable portion of the song. Second, logging must also be done for each song as it is rated. This can be stored with the subscriber identification, the song identification, the rating or a time/date stamp. Third, the user logon and logoff time must be logged. How the user logged off must also be captured (i.e. normal exit, timer). All logging activity is tagged with the identification of the corresponding session.

The log data is analyzed on a regular basis using an OLAP cubes model. The data is also compiled on a per song total statistics basis for a configurable amount of time so that the total number of times a song is skipped, deleted, played and rated is determined and the average rating derived. When the amount of available songs remaining to the player drops below a configurable threshold, the player initiates a process of starting a new session and getting a new play list.

All RNS users have access to the programming of all other listeners on the network. Each user of the network is called an “iJock”. Through a Web based interface, any ijock will be able to select any other ijock from a complete listing of all of the users of the network. By selecting another ijock, the user's player will temporarily reconfigure itself to the stored settings of the selected ijock and the player will begin to play the same play list that is currently stored for that ijock. In the event that a play list is not currently available, one will be generated by the MSA using the ijock's current settings. In this way, any user may select and hear the programming being sent to any other listener.

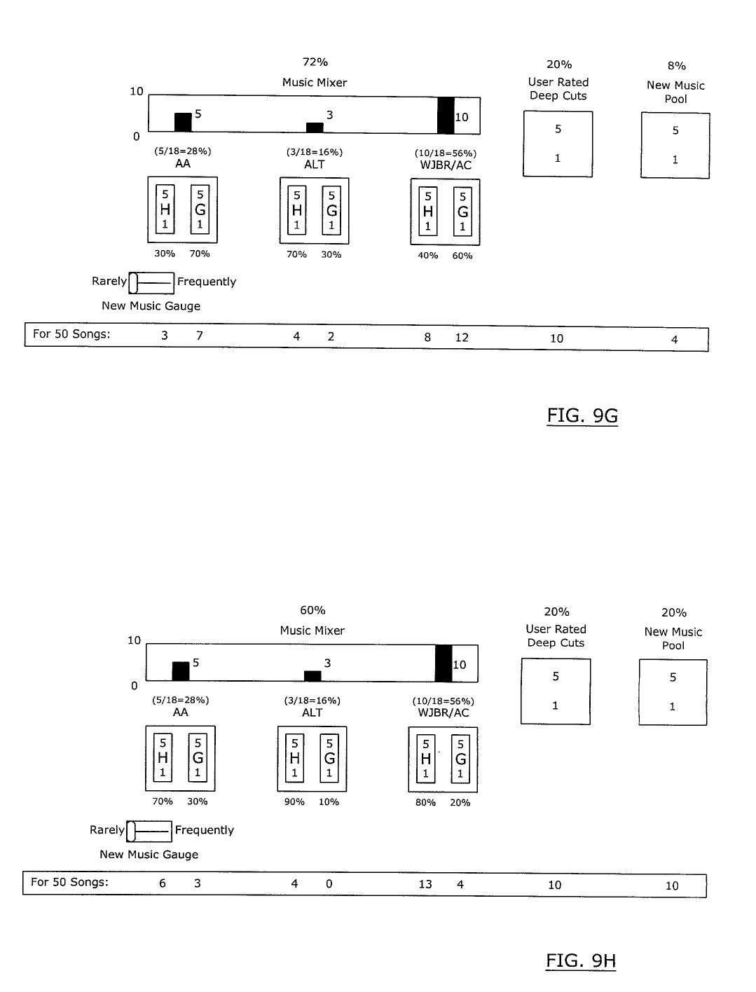

FIGS. 9A-9F illustrates various conditions that determine the music mix of a 50 song play list. As for FIGS. 6A and 6B, the information presented is determined within the MSA as previously discussed. Only the New Music Gauge setting is shown of the several gauges available to the user to illustrate the effect of New Music on the mix of music in the play list.

FIG. 9A illustrates the player at the default configuration. There are no user rated songs and the New Music Gauge does not indicate for New Music in the mix; all songs are selected at an even mix of Hit and Gold from the user's selected affiliate primary format. FIG. 9B illustrates the effect to the music mix when the user moves the New Music Gauge to “Frequently”. FIG. 9C illustrates the change to the music mix when the user adds other formats through the Music Selector Gauge. FIG. 9D illustrates the change to the music mix when the user provides 15 ratings of songs and artists. Fifteen ratings correspond to a 40% chance of success of the maximum possible 20% of user rated deep cuts, which is 8%.

FIG. 9E illustrates the change to the music mix when the user provides 125 ratings of songs (and artists). One hundred twenty five ratings correspond to a 100% chance of success of the maximum possible 20% of user rated Deep Cuts, which is 20%. FIG. 9F illustrates the effect to the music mix when the user deletes 20 songs. Twenty deletions correspond to a 40% of the New Music maximum of 20%, which is 8%. Since this value is less than the New Music gauge value of 20%, the 20% value is used. Therefore, there is no effective change for this scenario. FIG. 9G illustrates the change to the music mix when the user moves the New Music Gauge to “Rarely”. The user's previous deletes of FIG. 9F corresponds to a 40% of the New Music maximum of 20%, which is 8%. Since this value is greater than the New Music Gauge value of 0%, the 8% value is used. FIG. 9H illustrates the change to the music mix when the user deletes 60 songs. The 60 deletes corresponds to a 100% of the New Music maximum of 20%, which is 20%. Since this value is greater than the New Music Gauge value of 0%, the 20% value is used. Despite a New Music Gauge setting of 0%, the user will still receive new music selections.

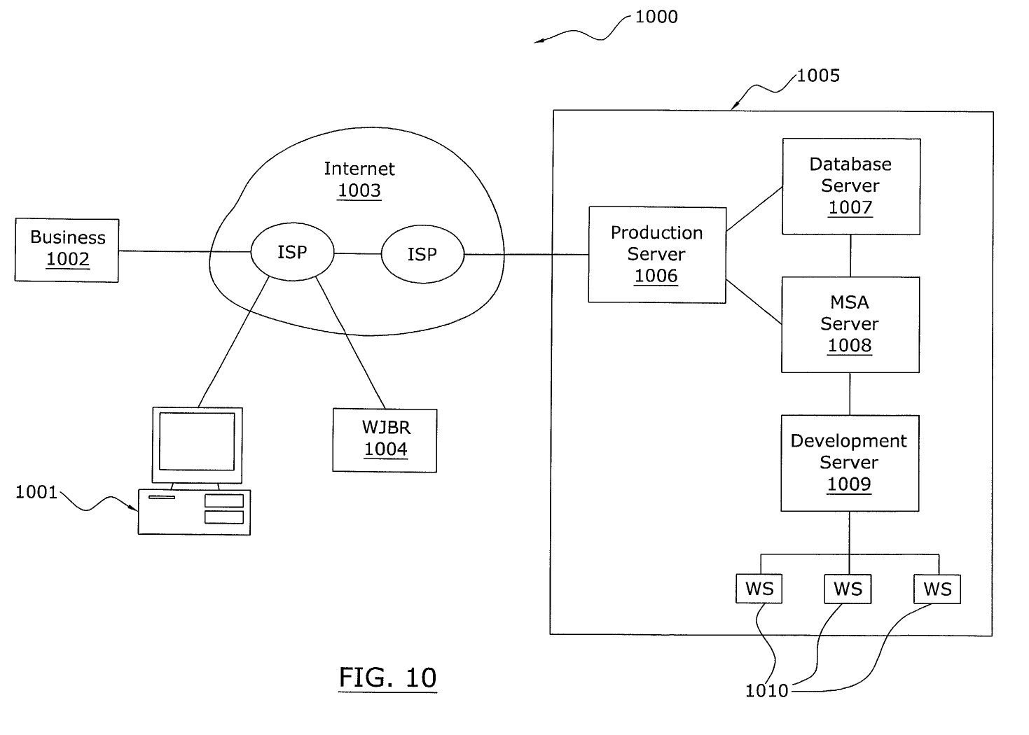

FIG. 10 is a simplified diagram 1000 of the Internet environment in which the Music Scheduling Algorithm is applied. An individual Internet user 1001 and a business network 1002 (with a server supporting a LAN with a number of user workstations) represent typical Internet users with a connection to an Internet Service Provider (ISP) for communication across the Internet 1009. An example (terrestrial) radio station, call letters WJBR 1010, provides a Website through which the user can request Internet music and optionally download a player. The Radio Network Service (RNS) 1003 is shown with a simplified network to provide the MSA based Internet radio service. The RNS collects the user music order and down streams the play list through a production server 1004 which is supported by a music database server 1005 and MSA server 1006. All of the RNS servers may be in different physical locations and connected across the Internet. The MSA server contains the Music Scheduling Algorithm to determine the unique play list for the individual user. The database server may be separate or included in the production or MSA server but provides a database of affiliate, national and other music lists as well as log user and affiliate accounts. A development server 1007 and workstations 1008 are exemplary representations of the necessary development and control network tools of the RNS staff.

In a second embodiment of the inventive solution, the listener is provided with the Internet radio service directly through a Web site provided by the RNS rather than transparently through an affiliate radio station. To setup, the Internet radio player application is downloaded from the RNS Web site and saved to the desktop of the user's personal computer or other appropriate Internet ready device. The application is launched from the desktop icon providing the user with convenient and direct programming access to the music services provided by the RNS. In addition to the user gauge settings previously discussed, the user selects the desired music formats and is provided with a Deep Cuts Gauge selector, functions previously provided by the affiliated radio station.

In a third embodiment of the inventive solution, the RNS incorporates multiple media players within the RNS custom radio player. The purpose of this is to control and eliminate the inherent buffering that occurs between songs when using a single media player thereby creating a “seamless” audio feel not found in most other media based players. To achieve this, the only production delay is while the first stream is buffered, and while that stream is played, several other streams are buffered and paused under the other players. Consequently, when a song is skipped or naturally ends, the next song is ready to play in another media player. The first player is then flushed and filled with another stream, one most likely to be played after two or three more elements have played.

It will be appreciated that in general, the inventive product is designed to manipulate the flow of Internet radio music so any listener is not able to predict but influence and enjoy the types of music they prefer to hear. This is accomplished by a Music Scheduling Algorithm employed by a Radio Network Service. The MSA is designed to create a play list of music that is expanded from any terrestrial radio experience through the rotation of user rated or inferred songs the user will like with the introduction of new songs and favorite songs that the user has long since forgotten. The inventive solution is designed to play music in a passive experience that the user likes on a regular basis.

As to a further discussion of the manner of usage and operation of the present invention, the same should be apparent from the above description. Accordingly, no further discussion relating to the manner of usage and operation will be provided.

The foregoing descriptions of embodiments of the invention have been presented for purposes of illustration and description only. They are not intended to be exhaustive or to limit the invention to the forms disclosed. Accordingly, many modifications and variations will be apparent to practitioners skilled in the art. Additionally, the above disclosure is not intended to limit the invention. The scope of the invention is defined by the appended claims.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. A method of a programmable algorithm to determine a unique play list for the individual Internet radio user comprising:
accessing normalized music pools;
identifying individual user information and user selected radio station information;
selecting music lists from the normalized music pools;
applying user calibrators;
correlating user rated songs with normalized music pools;
applying global calibrators;
applying dynamic calibrators; and
adjusting the play list in accordance with local laws.

2. A method as claimed in claim 1 where said normalized music pools is regularly updated.

3. A method as claimed in claim 2 where said normalized music pools comprise the affiliate music pool, national generic music pool, a new music pool and the user rated music pool.

4. A method as claimed in claim 1 where said identifying radio station information comprises radio station identification, allowed music formats, mix value of affiliate music and national music versus user rated deep cuts.

5. A method as claimed in claim 1 where said identifying user information comprises user identification and stored user files.

6. A method as claimed in claim 3 where said selecting music lists from the normalized music pools further comprises selecting music lists by music formats allowed by the affiliate radio station.

7. A method as claimed in claim 6 further comprises the affiliate music pool replaces the same music format of the national generic music pool.

8. A method as claimed in claim 1 where said user calibrators comprise user rated songs and artists and user song and artist deletions.

9. A method as claimed in claim 1 where said global calibrators comprise music selections influenced by the radio network service, radio stations and record labels.

10. A method as claimed in claim 1 where said dynamic calibrators comprises the radio station specified mix value of radio station and national music versus user rated deep cuts, the user music selector gauge setting and the new music gauge setting.

11. A method as claimed in claim 10 where the radio station specified mix value comprises a user deep cuts gauge setting.

12. A method as claimed in claim 1 where said local laws comprises the Digital Millennium Copyright Act (DMCA) enacted by the United States Congress.

13. A method as claimed in claim 12 where said adjusting the play list comprises removing songs in violation of the DMCA or replacing the play list with an emergency play list in the event the play list cannot conform to DMCA rules.

14. A method of a programmable algorithm to determine a unique play list for the individual Internet radio user comprising:
accessing normalized music pools;
identifying individual user information;
selecting music lists from the normalized music pools;
applying user calibrators;
correlating user rated songs with normalized music pools;
applying global calibrators;
applying dynamic calibrators; and
adjusting the play list in accordance with local laws.

15. A method as claimed in claim 14 where said normalized music pools is regularly updated.

16. A method as claimed in claim 15 where said normalized music pools comprise the national generic music pool, a new music pool and the user rated music pool.

17. A method as claimed in claim 14 where said identifying individual user information comprises user identification, selected music formats and stored user files.

18. A method as claimed in claim 14 where said user calibrators comprise user rated songs and artists and user song and artist deletions.

19. A method as claimed in claim 14 where said global calibrators comprise music selections influenced by the radio network service, radio stations and record labels.

20. A method as claimed in claim 14 where said adjusting the play list comprises removing songs in violation of the DMCA or replacing the play list with an emergency play list in the event the play list cannot conform to DMCA rules.
